(19) United States
(12) Patent Application Publication
(10) Pub. No.: US 2009/0271303 A1
(43) Pub. Date: Oct. 29, 2009

(54) ELECTRONIC BILL PROCESS AUTOMATION

(75) Inventors: Jeff Weng, Taipei (TW); Jyh-Shin Shue, Taipei (TW)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/111,806

(22) Filed: Apr. 29, 2008

(51) Int. Cl. G07F 19/00

(52) U.S. Cl. 705/34

(57) ABSTRACT

Disclosed are apparatus and methods for processing an electronic statement. In one embodiment, an electronic mail message addressed to an electronic mail address is received, the electronic mail message including bill information associated with a bill, where the bill information indicates a bill amount, a due date of the bill, a sender of the bill, and an addressee of the bill. A set of user preferences is obtained, and the bill information is processed according to the set of user preferences.

### BACKGROUND OF THE INVENTION

The present invention relates generally to computer implemented processing of electronic bills.

People often use a variety of services that are paid for on a monthly basis. As a result, many companies typically generate a monthly bill for these services. For example, a typical person might receive an electric bill and a phone bill on a monthly basis.

In addition, many individuals use credit cards to purchase goods and services. At the end of each month, such individuals typically receive a bill from the company or bank that has issued each credit card.

Bills are typically generated in a paper format and transmitted via the postal service. While the postal service is typically reliable, paper bills may be placed in the incorrect mail box. As a result, some bills may go unreceived.

Even after a paper bill has been received by the intended recipient, these paper bills are often difficult to track. Many people misplace bills after they have been received. Moreover, each bill is typically due on a different due date. As a result, many individuals forget to pay bills prior to their due date.

Accordingly, improved mechanisms for managing bills would be beneficial.

### SUMMARY OF THE INVENTION

Apparatus and methods for processing an electronic statement (i.e., electronic bill) are disclosed. In accordance with various embodiments, an electronic statement is transmitted in the form of an electronic mail message.

In one embodiment, an electronic mail message addressed to an electronic mail address is received, the electronic mail message including bill information associated with a bill, where the bill information indicates a bill amount, a due date of the bill, a sender of the bill, and an addressee of the bill. A set of user preferences is obtained, and the bill information is processed according to the set of user preferences.

In accordance with various embodiments, processing of bill information may include initiating an electronic payment, scheduling an electronic payment to be made at a later time, adding information associated with the bill to an electronic calendar maintained by a calendar application, and/or scheduling one or more notifications to be provided as reminders of an upcoming bill deadline.

In accordance with a specific embodiment, the system modifies the electronic mail message to include one or more hypertext links prior to providing the electronic mail message to the addressee's electronic mail box. The addressee of the bill may then establish his or her set of user preferences via these links.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a block diagram illustrating an example system in which various embodiments may be implemented.

FIG. 2 is a process flow diagram illustrating an example method of processing an electronic statement.

FIG. 3 is a diagram illustrating an example electronic statement that may be implemented in accordance with various embodiments.

FIG. 4 is a diagram illustrating an example graphical user interface that may be presented in order to obtain display preferences.

FIG. 5 is a diagram illustrating an example graphical user interface that may be presented in order to display an electronic mail box.

FIG. 6 is a diagram illustrating an example graphical user interface that may be presented in order to display a modified electronic statement.

FIG. 7 is a process flow diagram illustrating an example method of processing bill information in accordance with various embodiments.

FIG. 8 is a diagram illustrating example data that may be stored for purposes of bill payment.

FIG. 9A is a diagram illustrating example data that may be stored for purposes of calendaring a bill for payment.

FIG. 9B is a diagram illustrating example data that may be stored for purposes of issuing a notification of an upcoming bill due date.

FIG. 10 is a simplified diagram of a network environment in which specific embodiments of the present invention may be implemented.

FIG. 11 illustrates an example computer system in which specific embodiments of the present invention may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The disclosed embodiments enable an electronic statement (i.e., electronic bill) to be automatically processed. An electronic statement may be sent in the form of an electronic mail message that includes bill information associated with a bill. For example, the bill information may indicate a bill amount, a due date of the bill, a sender of the bill (e.g., phone company, utility company, etc.), and an addressee of the bill (e.g., name of the consumer and/or account number). Of course, the sender of the bill and the addressee of the bill may simply be identified by their respective electronic mail addresses as provided when the electronic statement is sent.

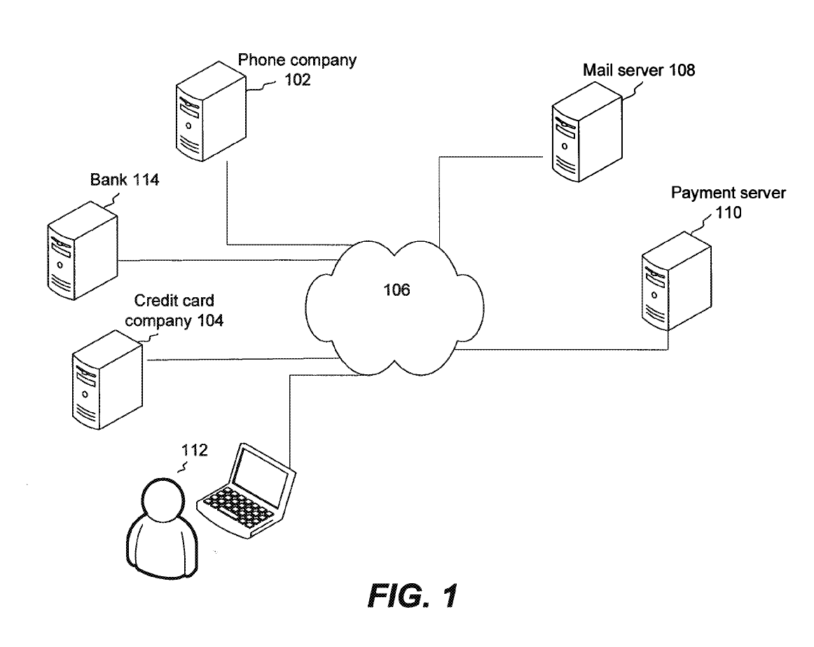

FIG. 1 is a block diagram illustrating an example system in which various embodiments supporting automated processing of electronic statements may be implemented. When a sender generates an electronic statement for transmission to a consumer, the sender may send the electronic statement via electronic mail using the sender's electronic mail address to one or more electronic mail addresses associated with the consumer. For example, the sender may be a company such as a phone company 102, a credit card company 104, or a bank. Once the electronic statement is transmitted over the Internet 106, a web site that hosts the electronic mail address may forward the electronic statement to an electronic mail box associated with the electronic mail address. Alternatively, the web site may generate and forward a different or modified electronic statement to the electronic mail address, as will be described in further detail below.

A web site that hosts the electronic mail address may be supported by one or more servers. In this example, the web site includes a mail server 108 and a payment server 110. However, it is important to note that the functions described herein may also be performed by a single server, as well as a greater number of servers.

Upon receiving the electronic statement from the sender, the mail server 108 may authenticate the electronic statement. More particularly, the mail server 108 may extract security and/or identification data to authenticate the sender of the electronic statement. Similarly, the mail server 108 may authenticate the format of the bill information provided in the electronic statement. Specifically, the format of the bill information may be verified against a standardized electronic statement format.

Assuming that the mail server 108 has authenticated the electronic statement, the mail server 108 may send a modified electronic statement including the bill information to the electronic mail box of the consumer. For example, the mail server 108 may modify the electronic statement according to a set of user display preferences, as will be described in further detail below. As another example, the mail server 108 may modify the electronic statement to include various information, as well as one or more hypertext links, as will be described in further detail below. The modified electronic statement may be referred to as a second electronic mail message. In some embodiments, the mail server 108 does not modify the electronic statement that the sender has transmitted prior to providing the electronic statement to the electronic mail box of the consumer.

In accordance with various embodiments, the mail server 108 may extract bill information from the electronic statement and store the bill information. In other embodiments, another server such as the payment server 110 may extract the bill information and store the bill information.

Upon reading the electronic statement in his or her mail box, consumer (i.e., addressee or user) 112 may specify one or more user preferences for processing the bill and corresponding bill information. Thus, user preferences may be bill-specific. It is also possible that the consumer 112 has already specified one or more user preferences for processing all bills addressed to the consumer's electronic mail address. For example, the consumer may want all of his or her bills to be automatically paid upon receipt by the system (e.g., where the consumer will not have access to his or her electronic mail for an extended period of time). Thus, the user preferences may include instructions for automated processing of all electronic statements received at the consumer's electronic mail address. It is also possible that a consumer in possession of multiple electronic mail addresses may generate a set of user preferences that are to be applied to all of these electronic mail addresses. In other words, the user preferences may be associated with a specific individual (e.g., addressee of the bill(s)), rather than a specific electronic mail address. The user preferences may also specify user preferences that are specific to a particular sender. For example, the user preferences may provide instructions for automated processing of bills from the phone company, where the user wants to handle different types of bills in different ways.

In accordance with various embodiments, the user preferences may indicate whether a user would like his or her bills, or a subset of these bills, to be paid automatically. A system setting instructing the automated payment of such bills may be referred to as “automode.” Similarly, the user preferences may indicate that all bills, or a subset of the bills, not be paid automatically. In other words, the user may wish to manually select a bill to be paid electronically. A system setting instructing the manual selection of such bills for electronic payment may be referred to as “manual mode.”

In accordance with one embodiment, the user may establish a threshold amount of a bill, where the system automated payment feature is in automode for bills having a bill amount that is less than the threshold amount. Automode may be useful for establishing automated payment of regular bills such as phone or electric bills that the user does not wish to review prior to payment. As another example, the user may establish that the system automated payment feature is in manual mode for bills having a bill amount that is greater than the threshold amount. Manual mode may be useful when the amount of a particular bill such as a credit card bill changes every month, enabling the user to confirm the bill amount and/or verify charges on the bill prior to proceeding with payment of the bill.

In accordance with one embodiment, the setting of a threshold amount may serve to trigger a notification to the user or another individual where a bill amount is above the threshold amount. For example, if a parent would like to review and control the manner in which their child's bills are paid via the system, a system setting may be established to notify the parent if their child's bill amount surpasses the threshold that has been established by the parent. Moreover, in this case, the system may be automatically set to manual mode where the child's bill amount is above the threshold, enabling the parent to review such bills before proceeding with their payment.

The payment server 110 may be responsible for automatically initiating electronic payments of the bill based upon the consumer's specified user preferences. For example, the consumer 112 may want the bill to be paid automatically (immediately), or may merely want the bill to be automatically paid by the bill due date. Such payments may include an amount that is the same as the bill amount or different from the bill amount. In one embodiment, the payment server 110 initiates an electronic transfer of funds from the consumer's bank account at a bank 114 to a bank account of the sender of the electronic statement (at the same bank or a different bank).

The mail server 108 may also perform a variety of other functions based upon the user preferences. For example, the mail server 108 may add some or all of the bill information to a calendar of the user. As another example, the mail server 108 may prepare, schedule, and/or generate a notification for transmission to the user. For example, such a notification may include some or all of the bill information and serve as a reminder of an impending bill due date.

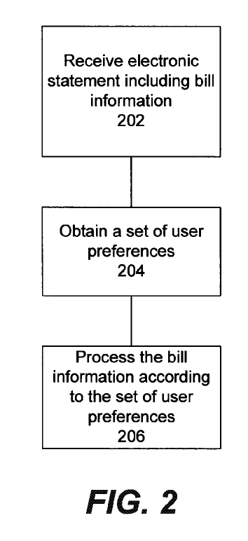

FIG. 2 is a process flow diagram illustrating an example method of processing an electronic statement. Upon receiving an electronic statement in the form of an electronic mail message addressed to an electronic mail address at 202, the system may authenticate the electronic statement. For example, authentication may include verifying that the electronic statement is a valid electronic statement that has been sent by the sender identified in the electronic statement.

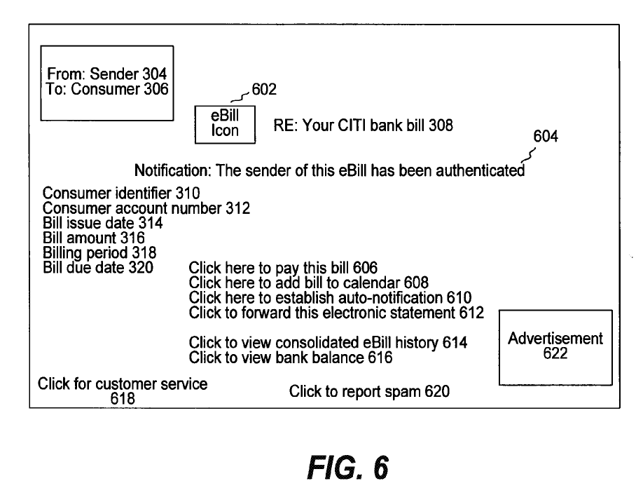

The system may then provide the electronic mail message to the electronic mail address. Alternatively, the system may modify the electronic mail message including the electronic statement and provide the modified electronic mail message to the electronic mail address. This modified electronic mail message may be referred to as a second electronic mail message. The second electronic mail message may include the bill information of the first electronic mail message, as well as additional information and/or hypertext links, as will be described in further detail below with reference to FIG. 6. An electronic mail message may be provided in the user's electronic mail box according to a set of user display preferences, as will be described in further detail below.

The system may also obtain a set of user preferences at 204. One or more of the user preferences may have been previously established by the consumer, such as where these user preferences are instructions for the processing of all electronic statements. Moreover, one or more of the user preferences may be obtained dynamically when the user opens an electronic statement, such as where the user preferences are directed to the automated processing of a specific electronic statement. For example, the consumer may specify one or more user preferences via one or more hypertext links provided in the second electronic mail message, as will be described in further detail below. Alternatively, the consumer may specify user preferences via other mechanisms, such as drop down menus, etc.

Assuming that the system has extracted the bill information or portion thereof from the electronic statement, the system may then process the bill information according to the set of user preferences (and/or system settings) at 206. Automated processing of bill information may include immediate electronic payment of the bill. Electronic payment may be initiated via a variety of payment services such as PAYPAL™, as well as direct bank transfer of funds. Automated processing of bill information may also include delayed bill payment. For example, the delayed bill payment may be automatically initiated on the due date of the bill or on a particular user-specified date that is prior to or on the due date of the bill. Other examples of automated processing include the addition of at least a portion of the bill information to the user's calendar, as well as the scheduling and transmission of a bill reminder notification. In addition or alternatively, it is also possible to process the bill information or portion thereof manually.

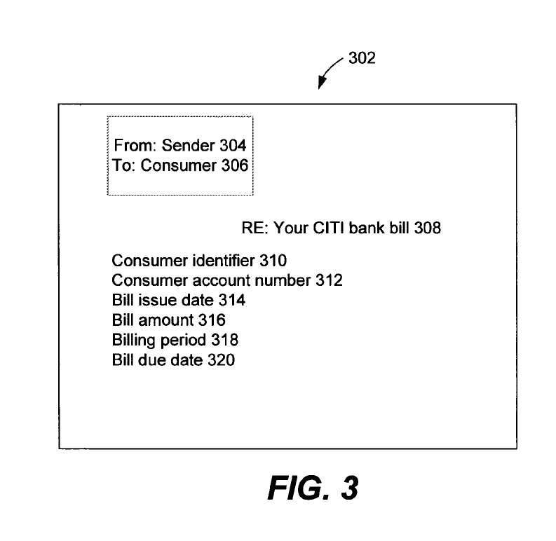

FIG. 3 is a diagram illustrating an example electronic statement that may be received at block 202 of FIG. 2 in accordance with various embodiments. Electronic statement 302 may identify a sender of the bill, as well as an addressee of the bill. As shown, the sender of the bill may be identified via an electronic mail address in the “From” field of an electronic message as shown at 306. Similarly, the addressee of the bill may be identified via an electronic mail address in the “To” field of the electronic mail message as shown at 308. Of course, the sender and the addressee of the bill may be identified in a different manner. For example, the sender of the bill may be identified by name (e.g., company name) in a portion of the electronic mail message, such as in the title of the electronic mail message, as shown at 310. As another example, the addressee of the bill may be directly identified by a consumer identifier 310 such as the consumer's name, or the addressee of the bill may be indirectly identified by a consumer account number 312. The consumer account number 312 may include any number or type of characters representing the consumer's account. The electronic statement 302 may further include additional bill information such as the bill issue date 314, the bill amount 316, an indication of the billing period 318 (e.g., end of the billing period), a bill due date 320, and/or a list of individual charges included in the bill (not shown).

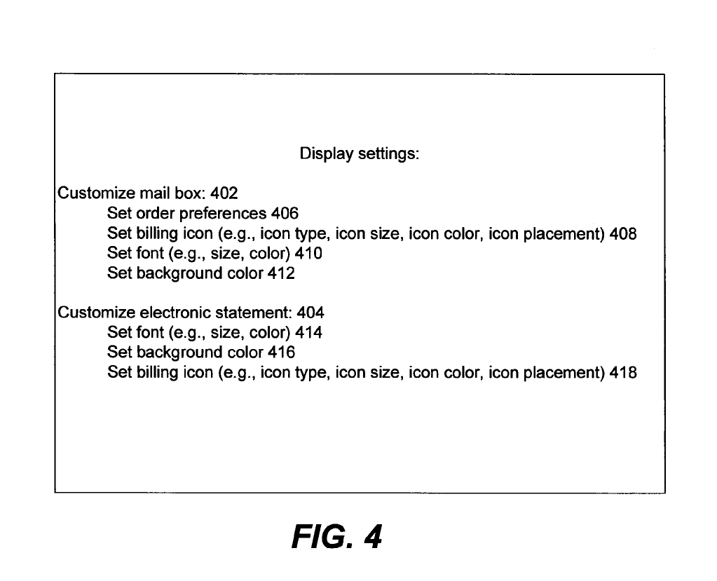

When a mail message including an electronic statement is provided for access by a user, this electronic mail message may be provided in accordance with a set of display preferences. FIG. 4 is a diagram illustrating an example graphical user interface that may be presented in order to obtain display preferences from a user. In this example, a user may establish two different types of display settings. First, the user may establish settings in order to customize the manner in which his or her mailbox is displayed, as shown at 402. Second, the user may establish settings in order to customize the manner in which an electronic statement (i.e., an electronic mail message including bill information) is displayed when the user opens the statement, as shown at 404. Any combination of the features set forth may be implemented alone or in combination with one another.

The user may customize the manner in which his or her mail box is presented at 402. The user may set order preferences 406 indicating an order in which electronic statements are to be presented in the mail box with respect to other electronic mail messages in the mail box. In other words, the user may prioritize the manner in which different types of electronic mail messages are presented in the electronic mail box. The user may also choose to display a billing icon at 408 next to an electronic mail message in the mail box, in order to signal to the user that this electronic mail message is an electronic statement including bill information. For example, the user may select an icon type (e.g., “$”, “BILL,” etc.), an icon size, an icon color, and/or exact placement of the icon. For instance, the icon may be placed next to the mail box entry or next to the title of the electronic mail message. The user may also set the font that may be used to display the electronic mail message in the mail box as shown at 410. For example, the user may establish a font size and/or font color. The font settings may be used to display information such as the title and sender of the electronic mail message. The user may also wish to set the background color 412 of the mail box or mail box entry including the electronic statement.

The user may also customize the manner in which an electronic statement is displayed as shown at 404 when the electronic mail message is opened by the user. For example, the user may set the font 414 and/or background color 416. The user may also choose to display a billing icon at 418 in the electronic mail message in order to signal to the user that this electronic mail message is an electronic statement including bill information. For example, the user may select an icon type (e.g., “$”, “BILL,” etc.), an icon size, an icon color, and/or exact placement of the icon within the electronic mail message.

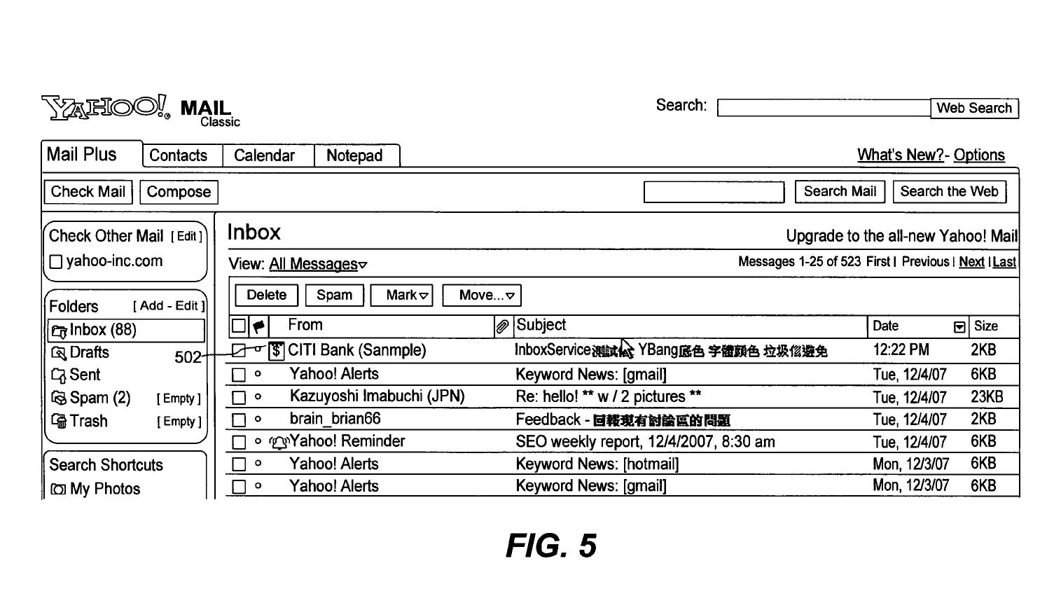

FIG. 5 is a diagram illustrating an example graphical user interface that may be presented in order to display an electronic mail box. In this example, an icon is displayed next to a mail box entry at 502, signifying that this electronic mail message is an electronic statement. As shown in this particular entry, this electronic statement is received from CITI Bank. In other embodiments, the bill amount and/or due date may be shown in the subject line of the electronic mail message.

The electronic statement that is provided in the user's electronic mail box may be an electronic statement such as that described above with reference to FIG. 3 after the electronic statement has been modified by the system to include additional information and/or hypertext links. FIG. 6 is a diagram illustrating an example graphical user interface that may be presented in order to display an electronic statement that has been modified in accordance with various embodiments. In this example, an icon 602 is displayed next to the title of the electronic statement. An authentication indicator 604 may also be provided in order to notify the user that the electronic statement and/or the sender of the electronic statement has been authenticated.

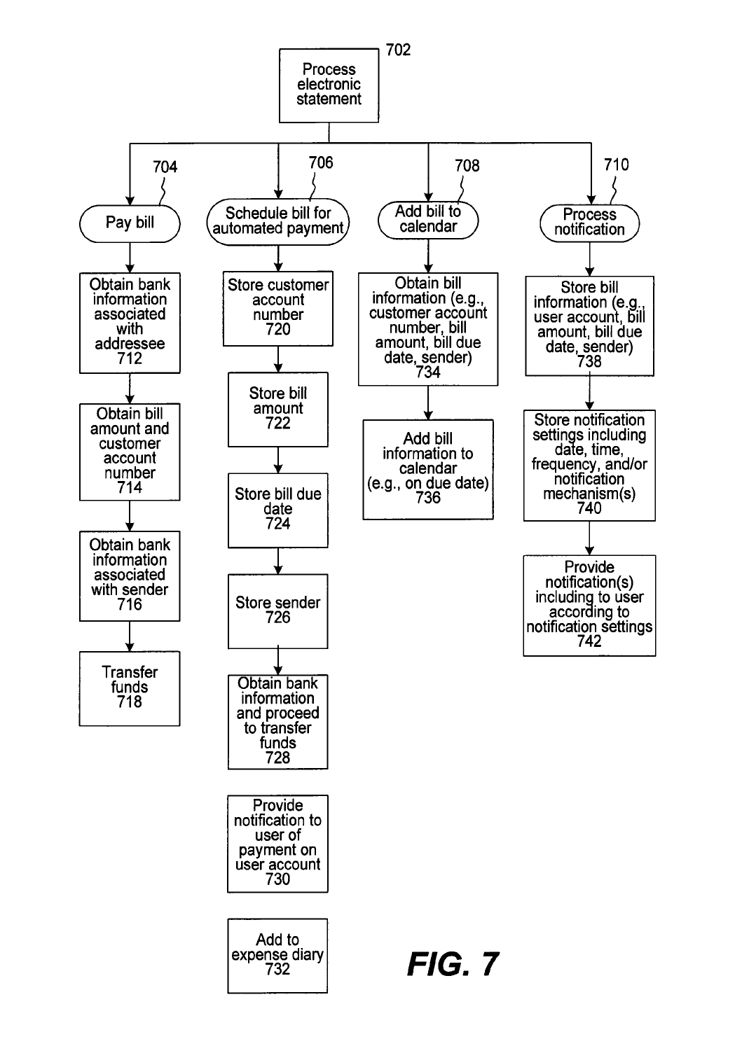

One or more hypertext links, represented as shown at 606-612, may be provided in the electronic statement in order to obtain a set of user preferences. More specifically, a set of user preferences associated with the bill may be obtained via one or more links in the electronic statement. For example one or more hypertext links may be provided to enable the user to pay the bill electronically at 606, as will be described in further detail below with reference to FIG. 7. For instance, the user may indicate that he or she wishes to pay the bill immediately, or at a later time. The current or later payment may be performed by the user, or may be initiated automatically by the system. For instance, such a payment may be performed automatically according to the user's preferences. As another example, the user may wish to add this bill to his or her calendar at 608, as will be described in further detail below with reference to FIG. 7. The user may also choose to establish an auto-notification at 610, which sends one or more notifications (e.g., reminders) of the bill, as will be described in further detail below with reference to FIG. 7. The user may also choose to forward the electronic statement to another individual's electronic mail address at 612. It is important to note that other types of user preferences may be obtained. Moreover, user preferences may be obtained via other mechanisms, such as menus, in addition to or instead of hypertext links embedded in the electronic statement. Furthermore, a user may wish to establish global user preferences to be applied to all electronic statements, or specific categories of electronic statements.

A number of other hypertext links may be provided in the electronic statement in order to provide further services to the user, as shown at 614-622. For instance, the user may wish to view a consolidated electronic statement history at 614. Such a statement history may indicate a total amount that has been billed to the user or paid by the user. The statement history may also categorize such amounts according to bill type(s) and/or time period(s). Additional hypertext links may be provided in order to enable the user to view his or her bank balance at 616, contact customer service at 618, and/or report the electronic statement as spam at 620. The system may also use at least a portion of the bill information and/or access additional information regarding the user to identify a type of advertisement, as well as one of a plurality of advertisements that may be automatically provided to the user as shown at 622. In accordance with various embodiments, the manner in which the hypertext links are presented may be customized by each sender.

Although not presented in this example, the electronic statement may include other information or provide hypertext links to other services. For example, the electronic statement may provide access to an online calculator. Moreover, various services may be made available via other mechanisms, such as menus, in addition to or instead of hypertext links embedded in the electronic statement.

In accordance with various embodiments, if a privacy agreement has been made between the sender and the addressee, the sender may receive a notification indicating that the delivery of the electronic statement has been successful. Similarly, the sender may receive a notification when the user opens the electronic statement.

In one set of embodiments, the system may automatically forward the electronic statement to a second electronic mail address if the electronic statement has not been processed within a pre-established date. For instance, the pre-established date may be determined based upon the last due date and/or user preferences.

Once the set of user preferences have been obtained, the system may process the bill information in accordance with the set of user preferences. FIG. 7 is a process flow diagram illustrating an example method of processing bill information provided in an electronic statement 702 in accordance with various embodiments. In this example, the system may automatically pay the bill at 704 or the system may schedule the bill for automated payment at a later time at 706. The system may also add the bill to a calendar of the user at 708 and/or process notifications at 710.

If the set of user preferences indicates that the user would like to pay the bill immediately as shown at 704, the system may initiate an electronic payment to the sender of the bill on behalf of the addressee of the bill. In one embodiment, the system may initiate a transfer of funds from a bank account of the addressee of the bill to a bank account associated with the sender of the bill. In order to initiate the transfer, the system may obtain bank information associated with the addressee at 712. For instance, the bank information may include a bank identifier and a bank account number. This information may be retrieved from a record associated with the addressee. Alternatively, this information may be obtained from the user if this is the first time the user has used the system's automated payment service. The system may also obtain at least a portion of the bill information such as the bill amount at 714, the customer account number (or customer identifier) and/or the identity of the sender. For example, the bill information may be retrieved from memory or may be obtained from the electronic statement. Of course, the user may specify an amount to be transferred that is different from the bill amount. From the identity of the sender, the system may retrieve bank information associated with the sender of the bill from a record associated with the sender at 716. The system may then automatically transfer the bill amount or a user-specified amount from the bank account of the addressee to the sender's bank account at 718. The system may also provide additional information in association with the transfer of funds such as a customer identifier or customer account number in order to ensure that the transfer of funds will be credited to the correct customer. In other embodiments, the system may initiate the electronic payment via another mechanism. For example, the system may access a standard online payment system such as PAYPAL™.

Alternatively, the set of user preferences may indicate that the user would like to schedule the bill for an automated payment to be made at a later date as shown at 706. In order to schedule the bill to be paid at a later date, the system may store at least a portion of the bill information such as a customer identifier or customer account number on which an automated payment is to be made at 720, the payment amount (a user-specified amount or bill amount) to be paid at 722, the bill due date (or a user-specified date) on which the payment is to be made at 724, and/or the identity of the sender of the bill at 726 (and/or the sender's bank information). Other information such as the user's electronic mail address and bill title may also be stored in order to enable the system to notify the user once an automated payment has been completed. In this manner, the system may schedule the bill for an automated payment to be made prior to or on the due date of the bill. The user may also provide bank account information to the system. On the bill due date (or a user-specified date), the system may retrieve bank information of the sender and addressee and automatically transfer the bill amount (or user-specified amount) from the bank account of the addressee to the bank account of the sender at 728. The system may also provide additional information in association with the transfer of funds such as a customer identifier or customer account number in order to ensure that the transfer of funds will be credited to the correct customer. In other embodiments, the system may initiate the electronic payment via another mechanism, as set forth above.

The system may also provide a confirming notification to the addressee that the automated payment has been made at 730. For instance, such a notification may include the title of the bill and may be sent to the addressee's electronic mail address. In addition, the system may add information such as the transferred amount, identity of the sender of the electronic statement, and/or the payment date to an expense diary at 732.

If the set of user preferences indicate that the user would like to add the bill to his or her calendar electronic as shown at 708, bill information including a customer account number, bill due date, bill amount, and/or sender of the bill may be obtained (e.g., from memory or from the electronic statement) at 734. The set of user preferences may also indicate a date of the calendar on which the bill information is to be added. At least a portion of the obtained bill information may be added to the calendar of the addressee of the bill on the due date of the bill or a user-specified date at 736.

The set of user preferences may indicate that the user would like to receive a notification (e.g., reminder) of the bill and upcoming due date as shown at 710. In order to schedule a notification, at least a portion of the bill information may be stored at 738. For instance, bill information including a customer account number, bill due date, bill amount, and/or sender of the bill may be stored. One or more notification(s) may be transmitted in accordance with the set of user preferences, or in accordance with system settings. Such user preferences or system settings may indicate a time, date, and/or frequency of notifications to be transmitted. Moreover, the user preferences or system settings may indicate one or more communication mechanisms via which the notification(s) is to be provided. For instance, the communication mechanisms may include electronic mail, instant messenger (IM), and/or text messages (e.g., sent via Short Message Service (SMS). Notification settings such as time at which the notification is to be provided, date on which the notification is to be provided, frequency with which the notification is to be provided, and/or preferred notification mechanism(s) via which each notification is to be transmitted may be stored at 740. For instance, a notification may be provided prior to or on the due date of the bill. In this manner, a notification of the bill to be provided to the addressee of the bill may be scheduled. The system may then provide one or more notifications the user in accordance with the notification settings (e.g., user-specified and/or system settings) at 742. Each of the notifications may include at least a portion of the bill information (e.g., sender of the bill, bill due date, and/or bill amount). Accordingly, the system may provide one or more notification(s) of the bill to the addressee of the bill via one or more communication mechanisms prior to or on the due date of the bill.

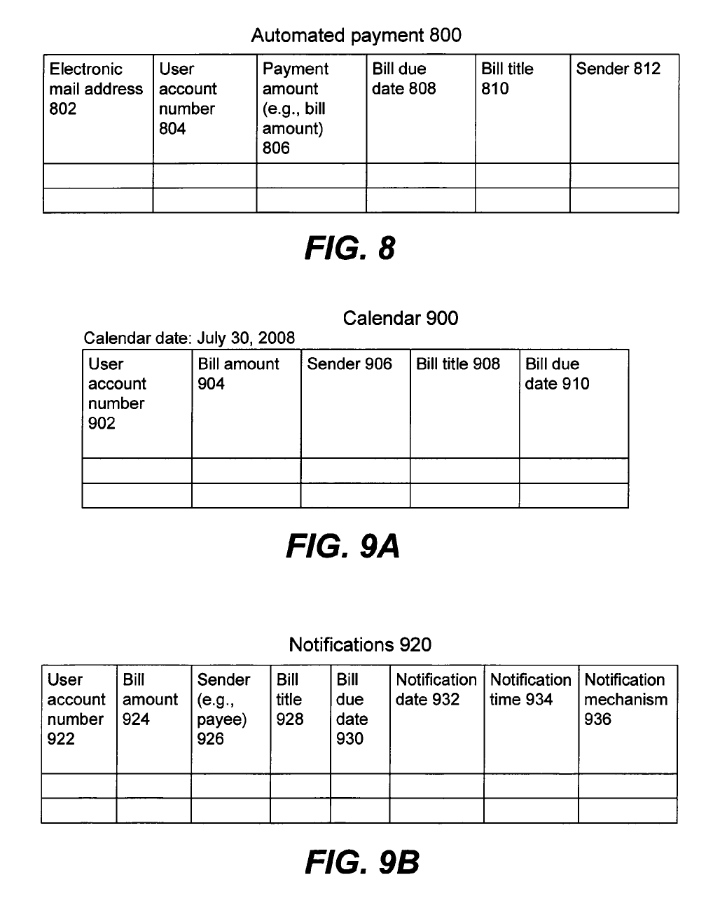

In order to schedule an automated payment to be made at a later date, bill information may be stored. FIG. 8 is a diagram illustrating example data 800 that may be stored for purposes of bill payment. The data 800 may include an electronic mail address of the user 802, a customer account number associated with the bill 804, a payment amount 806, a bill due date 808, a bill title 810, and/or sender of the bill 812.

As set forth above, a user may wish to add information associated with a bill to the user's calendar. This information may be added to one or more dates on the user's calendar, as desired by the user. FIG. 9A is a diagram illustrating example data that may be stored in association with a user's on-line calendar 900. In this example, data associated with the bill is added to Jul. 30, 2008 of the user's electronic calendar. More specifically, data such as a customer account number (e.g., credit card number) 902, bill amount 904, sender of the bill 906, bill title 908, and/or bill due date 910 may be stored.

FIG. 9B is a diagram illustrating example data that may be stored for purposes of issuing a notification 920 of an upcoming bill due date. As shown in this example, the data may include a user account number 922, bill amount 924, sender of the bill (e.g., payee) 926, title of the bill 928, bill due date 930, notification date 932, notification time 934, and/or notification mechanism 936. The data may also indicate a frequency with which such a notification may be transmitted.

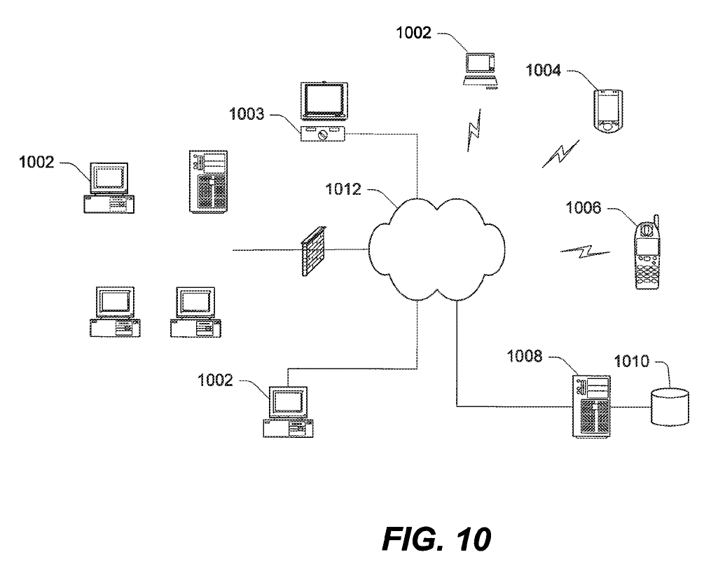

Embodiments of the present invention may be employed to process an electronic statement in any of a wide variety of computing contexts. For example, as illustrated in FIG. 10, implementations are contemplated in which the relevant population of users interact with a diverse network environment via any type of computer (e.g., desktop, laptop, tablet, etc.) 1002, media computing platforms 1003 (e.g., cable and satellite set top boxes and digital video recorders), handheld computing devices (e.g., PDAs) 1004, cell phones 1006, or any other type of computing or communication platform.

And according to various embodiments, input that is processed in accordance with the invention may be obtained using a wide variety of techniques. For example, a set of user preferences may be obtained from a user's interaction with a local application, web site or web-based application or service and may be accomplished using any of a variety of well known mechanisms for obtaining information from a user. However, it should be understood that such methods of obtaining input from a user are merely examples and that a set of user preferences may be collected in many other ways.

Once a set of user preferences are obtained, an electronic statement may be handled according to the invention in some centralized manner. This is represented in FIG. 10 by server 1008 and data store 1010 which, as will be understood, may correspond to multiple distributed devices and data stores. The invention may also be practiced in a wide variety of network environments (represented by network 1012) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. The electronic statement processing apparatus of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store bill information, records associated with consumers and/or senders of bills, user preferences, calendar data, notification settings, electronic bill statements and summaries thereof, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

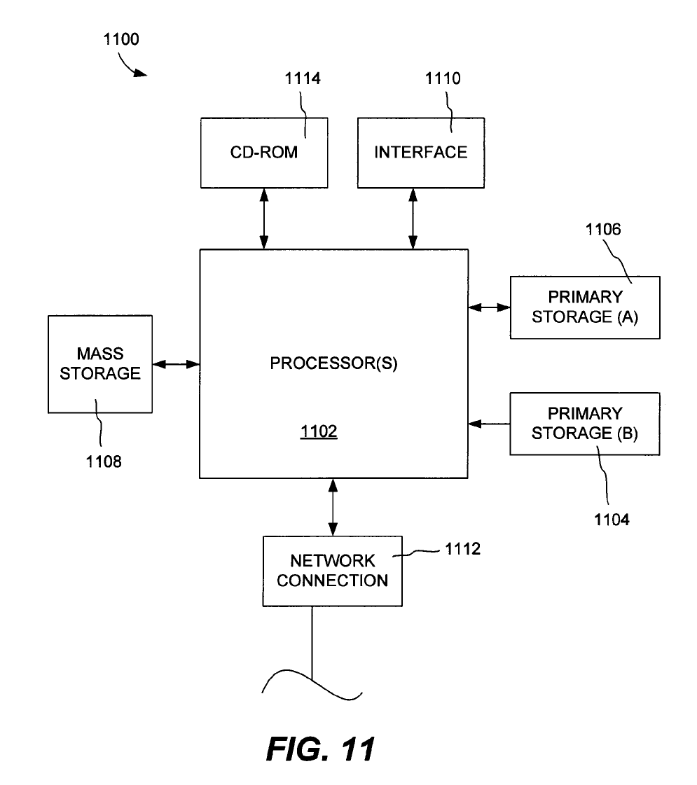

FIG. 11 illustrates a typical computer system that, when appropriately configured or designed, can serve as a system of this invention. The computer system 1100 includes any number of processors 1102 (also referred to as central processing units, or CPUs) that are coupled to storage devices including primary storage 1106 (typically a random access memory, or RAM), primary storage 1104 (typically a read only memory, or ROM). CPU 1102 may be of various types including microcontrollers and microprocessors such as programmable devices (e.g., CPLDs and FPGAs) and unprogrammable devices such as gate array ASICs or general purpose microprocessors. As is well known in the art, primary storage 1104 acts to transfer data and instructions uni-directionally to the CPU and primary storage 1106 is used typically to transfer data and instructions in a bi-directional manner. Both of these primary storage devices may include any suitable computer-readable media such as those described above. A mass storage device 1108 is also coupled bi-directionally to CPU 1102 and provides additional data storage capacity and may include any of the computer-readable media described above. Mass storage device 1108 may be used to store programs, data and the like and is typically a secondary storage medium such as a hard disk. It will be appreciated that the information retained within the mass storage device 1108, may, in appropriate cases, be incorporated in standard fashion as part of primary storage 1106 as virtual memory. A specific mass storage device such as a CD-ROM 1114 may also pass data uni-directionally to the CPU.

CPU 1102 may also be coupled to an interface 1110 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1102 optionally may be coupled to an external device such as a database or a computer or telecommunications network using an external connection as shown generally at 1112. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
receiving an electronic mail message addressed to an electronic mail address, the electronic mail message including bill information associated with a bill, the bill information indicating a bill amount, a due date of the bill, a sender of the bill, and an addressee of the bill;
obtaining a set of user preferences; and
processing the bill information according to the set of user preferences.

2. The method as recited in claim 1, wherein processing the bill information according to the set of user preferences comprises:
initiating an electronic payment to the sender on behalf of the addressee.

3. The method as recited in claim 1, wherein processing the bill information according to the set of user preferences comprises:
storing at least a portion of the bill information; and
scheduling the bill for payment to be made prior to or on the due date of the bill.

4. The method as recited in claim 1, wherein processing the bill information according to the set of user preference is done automatically.

5. The method as recited in claim 1, wherein processing the bill information according to the set of user preference is done manually.

6. The method as recited in claim 1, wherein automatically processing the bill information according to the set of user preferences comprises:
adding at least a portion of the bill information to an electronic calendar.

7. The method as recited in claim 1, wherein automatically processing the bill information according to the set of user preferences comprises:
storing at least a portion of the bill information;
scheduling a notification of the bill to be provided to the addressee; and
providing a notification of the bill to the addressee via one or more communication mechanisms prior to or on the due date of the bill.

8. The method as recited in claim 1, the method further comprising:
composing and providing a second electronic mail message addressed to the electronic mail address, the second electronic mail message including the bill information and one or more hypertext links;
wherein obtaining a set of user preferences includes receiving the set of user preferences via at least one of the one or more hypertext links in the second electronic mail message.

9. The method as recited in claim 1, further comprising:
identifying one of a plurality of advertisements using at least a portion of the bill information; and
automatically providing the identified advertisement.

10. An apparatus, comprising:
a processor; and
a memory, at least one of the processor or the memory being adapted for:
receiving an electronic mail message addressed to an electronic mail address, the electronic mail message including bill information associated with a bill, the bill information indicating a bill amount, a due date of the bill, a sender of the bill, and an addressee of the bill;
obtaining a set of user preferences; and
automatically processing the bill information according to the set of user preferences.

11. The apparatus as recited in claim 10, wherein automatically processing the bill information according to the set of user preferences comprises:
initiating an electronic payment to the sender on behalf of the addressee.

12. The apparatus as recited in claim 10, wherein automatically processing the bill information according to the set of user preferences comprises:
storing at least a portion of the bill information; and
scheduling the bill for automated payment to be made prior to or on the due date of the bill.

13. The apparatus as recited in claim 10, wherein automatically processing the bill information according to the set of user preferences comprises:
adding at least a portion of the bill information to an electronic calendar.

14. The apparatus as recited in claim 10, wherein automatically processing the bill information according to the set of user preferences comprises:
storing at least a portion of the bill information;
scheduling a notification of the bill to be provided to the addressee; and
providing a notification of the bill to the addressee via one or more communication mechanisms prior to or on the due date of the bill.

15. The apparatus as recited in claim 10, further comprising:
composing and providing a second electronic mail message addressed to the electronic mail address, the second electronic mail message including the bill information and one or more hypertext links;
wherein obtaining a set of user preferences includes obtaining the set of user preferences via at least one of the one or more hypertext links in the second electronic mail message.

16. The apparatus as recited in claim 10, further comprising:
identifying one of a plurality of advertisements using at least a portion of the bill information; and
automatically providing the identified advertisement.

17. A computer-readable medium storing thereon computer readable instructions, comprising:
instructions for receiving an electronic mail message addressed to an electronic mail address, the electronic mail message including bill information associated with a bill, the bill information indicating a bill amount, a due date of the bill, a sender of the bill, and an addressee of the bill;
instructions for obtaining a set of user preferences; and
instructions for automatically processing the bill information according to the set of user preferences.

18. The computer-readable medium as recited in claim 17, wherein the instructions for processing the bill information according to the set of user preferences comprises:
instructions for initiating an electronic payment to the sender on behalf of the addressee.

19. The computer-readable medium as recited in claim 17, wherein the instructions for automatically processing the bill information according to the set of user preferences comprises:
instructions for storing at least a portion of the bill information; and
scheduling the bill for automated payment to be made prior to or on the due date of the bill.

20. The computer-readable medium as recited in claim 17, wherein the instructions for automatically processing the bill information according to the set of user preferences comprises:
instructions for adding at least a portion of the bill information to an electronic calendar.

21. The computer-readable medium as recited in claim 17, wherein the instructions for automatically processing the bill information according to the set of user preferences comprises:
instructions for storing at least a portion of the bill information;
instructions for scheduling a notification of the bill to be provided to the addressee; and
instructions for providing a notification of the bill to the addressee via one or more communication mechanisms prior to or on the due date of the bill.

21. The computer-readable medium as recited in claim 17, wherein the instructions for obtaining a set of user preferences comprises:
instructions for obtaining a set of user preferences associated with a category of bills.

22. The computer-readable medium as recited in claim 17, further comprising:
instructions for identifying one of a plurality of advertisements using at least a portion of the bill information; and
instructions for automatically providing the identified advertisement.

23. A method, comprising:
receiving an electronic mail message addressed to an electronic mail address, the electronic mail message including bill information and one or more hypertext links, the bill information indicating a bill amount, a due date of the bill, a sender of the bill, and an addressee of the bill; and
submitting a set of user preferences via at least one of the one or more hypertext links;
thereby enabling the bill information to be processed according to the set of user preferences.

24. The method as recited in claim 23, wherein the set of user preferences indicate a request to initiate an electronic payment to the sender on behalf of the addressee.

25. The method as recited in claim 23, wherein the set of user preferences indicate a request to schedule the bill for payment to be made prior to or on the due date of the bill.

26. The method as recited in claim 23, wherein the set of user preferences indicate a request to add at least a portion of the bill information to an electronic calendar.

27. The method as recited in claim 23, wherein the set of user preferences indicate a request to provide a notification of the bill to the addressee via one or more communication mechanisms prior to or on the due date of the bill.

28. An apparatus, comprising:
a processor; and
a memory, at least one of the processor or the memory being adapted for:
receiving an electronic mail message addressed to an electronic mail address, the electronic mail message including bill information and one or more hypertext links, the bill information indicating a bill amount, a due date of the bill, a sender of the bill, and an addressee of the bill; and
submitting a set of user preferences via at least one of the one or more hypertext links;
thereby enabling the bill information to be processed according to the set of user preferences.

29. The apparatus as recited in claim 28, wherein the set of user preferences indicate a request to initiate an electronic payment to the sender on behalf of the addressee.

30. The method as recited in claim 28, wherein the set of user preferences indicate a request to schedule the bill for payment to be made prior to or on the due date of the bill.
